(19) United States
(12) Patent Application Publication
(10) Pub. No.: US 2003/0214217 A1
(43) Pub. Date: Nov. 20, 2003

(54) Color cathode ray tube

(76) Inventors: Hidemasa Komoro, Chosei (JP); Kenichi Watanabe, Ootaki (JP); Kazunari Noguchi, Chiba (JP); Gou Uchida, Mobara (JP); Shoji Shirai, Mobara (JP)

Correspondence Address: Christopher E. Chalsen, Milbank, Tweed, Hadley & McCloy, LLP, One Chase Manhattan Plaza, New York, NY, 10005-1413, US

(21) Appl. No.: 10/429,640

(22) Filed: May 5, 2003

(30) Foreign Application Priority Data
May 17, 2002 (JP) 2002-142963

(51) Int. Cl. H01J 29/50

(52) U.S. Cl. 313/414; 313/432

(57) ABSTRACT

Out of focusing electrodes which face each other in an opposed manner and constitute an electrostatic quadruple lens, one focusing electrode includes planar correction electrode plates which extend parallel to a tube axis while sandwiching electron beams from above and below. Here, the correction electrode plates include a reinforcing mechanism for suppressing the deformation or the displacement of the planar correction electrode plates. By suppressing the deformation and the displacement of the planar correction electrode plates which form the electrostatic quadruple lens, it is possible to provide a color cathode ray tube capable of exhibiting excellent focusing characteristics over an entire screen.

### BACKGROUND OF THE INVENTION

1. Field of the Invention

The present invention relates to a cathode ray tube, and more particularly to a color cathode ray tube having an electron gun capable of exhibiting excellent electrostatic quadruple lens characteristics.

2. Description of the Related Art

A cathode ray tube which is used as a television picture receiving tube, a monitor tube of an information terminal, other display tube or the like forms a given image by scanning electron beams emitted from an electron gun in two directions consisting of horizontal and vertical directions on a phosphor screen on which a phosphor is formed (hereinafter also referred to as “screen”. In an electron gun served for this type of color cathode ray tube, to obtain favorable focusing characteristics (referred to as “focusing characteristics” hereinafter) over the whole area of the phosphor screen, it is necessary to control the emitted electron beams into a beam spot shape landed on the phosphor screen in response to deflection angles of the electron beams.

Recently, a display monitor or a television receiver set which mounts a flat tube forming an outer surface of a panel constituting a display screen flat (flat-face type color cathode ray tube) thereon has been practically used. Particularly with respect to the flat tube having a large screen having an effective diagonal diameter of 51cm or more, the difference in focusing of electron beams (hereinafter referred to as “focusing”) is large between a center portion and a peripheral portion of the screen.

As a countermeasure to reduce this focusing difference, there has been proposed a method in which a focusing electrode constituting an electron gun is divided into a plurality of electrode members and an electrostatic quadruple and an image distortion correction lens are formed between these electrode members. By applying a focusing voltage of a fixed voltage and another focusing voltage which is formed by superposing a dynamic voltage being changed in synchronism with a deflection quantity to a fixed voltage to respective divided focusing electrodes, the prevention of deterioration of focusing in a periphery of a screen attributed to the increase of a deflection angle can be improved. Such a technique is disclosed in JP-A-2-189842, JP-A-2000-277029 and the like.

FIG. 16a and FIG. 16b are schematic cross-sectional views of an inline type electron gun of a color cathode ray tube shown in FIG. 1 of the above-mentioned JP-A-2000-277029, wherein FIG. 16a is a horizontal cross-sectional view as viewed from the direction perpendicular to the inline direction and FIG. 16b is a vertical cross-sectional view as viewed from the inline direction. In FIG. 16a and FIG. 16b, numeral 1 indicates cathodes, numeral 2 indicates a first electrode (control electrode) and numeral 3 indicates a second electrode (acceleration electrode). A beam generating part is formed of the cathodes 1, the control electrode 2 and the acceleration electrode 3. Numeral 4 indicates a third electrode. A pre-focusing lens is formed of the acceleration electrode 3 and the third electrode 4.

A fourth electrode 5 and a fifth electrode (focusing electrode) 6 are arranged at a phosphor screen side of the third electrode 4. The fourth electrode 5 is electrically connected with the second electrode 3 so as to assume the same potential and a pre-focusing voltage of approximately several hundreds V is applied to the fourth electrode 5. Further, the electron gun includes the fifth electrode 6 and a sixth electrode 7 (anode electrode) to which a maximum voltage (anode voltage) is applied. Here, a shield cup 8 is mounted on the sixth electrode 7 and an anode voltage Eb is applied to the sixth electrode 7 through this shield cup 8.

Further, the focusing electrode 6 is divided into four electrodes, that is, a first focusing electrode 61, a second focusing electrode 62, a third focusing electrode 63 and a fourth focusing electrode 64 and these focusing electrodes are arranged continuously in the tube axis direction. The third electrode 4, the first focusing electrode 61 and the third focusing electrode 63 are electrically connected to each other. On the other hand, the fourth focusing electrode 64 which faces the sixth electrode (anode) 7 and forms a main lens is electrically connected with the second focusing electrode 62.

In portions of the first focusing electrode 61 and the second focusing electrode 62 which face each other in an opposed manner, openings are formed at the first focusing electrode 61 side in the horizontal direction, that is, in the three beam aligning direction (inline direction), openings which are elongated in the vertical direction are formed at the second focusing electrode 62 side, and these openings face each other. Accordingly, by applying the above-mentioned dynamic voltage to the opposing portions of the first focusing electrode 61 and the second focusing electrode 62, an electrostatic quadruple lens 601 having an action of deforming passing electron beams in a laterally elongated manner is formed. Further, at a third focusing electrode 63 side of the second focusing electrode 62, horizontal correction plates 6H having a planer shape which are positioned so as to sandwich three electron beams in the vertical direction in common are provided and, at the same time, at a second focusing electrode 62 side of the third focusing electrode 63, planar vertical correction plates 6V which are positioned so as to sandwich three electron beams individually in the horizontal direction are provided.

Then, by applying a dynamic voltage in a state that the vertical correction plates 6V are combined with the horizontal correction plates 6H while being sandwiched by the horizontal correction plates 6H, an electrostatic quadruple lens 602 having an action of deforming passing electron beams in a longitudinally elongated manner is formed. With respect to the above-mentioned two electrostatic quadruple lenses, in view of shapes thereof, the latter electrostatic quadruple lens 602 exhibits the stronger lens action than the former electrostatic quadruple lens 601 in general. Further, between the third focusing electrode 63 and the fourth focusing electrode 64, electron beam passing holes having elongated openings in the vertical direction respectively are arranged to face each other in an opposed manner so as to form a slit lens 603 having an curvature-of-field aberration correction function which exhibits large and small focusing forces in both directions consisting of the horizontal direction and the vertical direction.

It is more effective to provide the above-mentioned slit lens 603 in the vicinity of the main lens for assisting the curvature-of-field aberration correction function of the main lens. Further, this electron gun adopts a multi-stage dynamic focus (MDF) method which divides the focusing electrode 6 into a plurality of electrode members. By applying a fixed focusing voltage Vfs and a dynamic correction voltage which is formed by superposing a dynamic voltage dVf which changes in synchronism with a deflection quantity to a fixed voltage Vfd to the divided electrode members, an electrostatic quadruple lens and an image distortion correction lens for obtaining desired focusing characteristics over the whole area of a phosphor screen are formed. The electrostatic quadruple lens controls a cross section of the beam spot which passes the electrostatic quadruple lens portion so as to form a shape of the beam spot on the phosphor screen into a shape close to a circle.

On the other hand, when the dynamic voltage dVf is increased, that is when the deflection quantity of electron beam is large (when the electron beam is deflected to a peripheral portion of the screen), the potential difference in the curvature-of-field correction lens becomes small and hence, the lens intensity is decreased. Accordingly, the force to focus the electron beams becomes weak at the time of deflecting the electron beams and hence, the image distortion is corrected.

The color cathode ray tube having the above-mentioned constitution has excellent characteristics that since the focusing electrode disposed close to the anode is constituted of a plurality of electrode members and the electrostatic quadruple lens is formed of a planar vertical correction plate 6V and the planar horizontal correction plate 6H, the desired focusing characteristics can be obtained over the whole area of the phosphor screen. However, it has been found that it is difficult to obtain the desired electrostatic quadruple lens characteristics with the above-mentioned constitution. This finding is explained in conjunction with drawings.

FIG. 17 is a schematic view showing a cross section of the above-mentioned horizontal and vertical correction plates 6H, 6V shown in FIG. 16a and FIG. 16b perpendicular to the tube axis. In FIG. 17, four planar vertical correction plates 6V1 to 6V4 are arranged at a given interval S1 in the horizontal direction and form respective electrostatic quadruple lens together with the planar horizontal correction plates 6H for a center beam Bc and two side beams Bs1 and Bs2 respectively.

In such a constitution, when the planar vertical correction plate 6V2 is displaced to a position 6V21 indicated by a dotted line, the above-mentioned electrostatic quadruple lens characteristics with respect to the center beam Bc and the one-side side beam Bs1 are changed. That is, it is necessary for the correction plates of the focusing electrodes which form the electrostatic quadruple lens to ensure that the interval between the correction plates which face each other in an opposed manner while sandwiching electron beams is parallel from proximal ends to distal ends of the correction plates and within a given size. However, when the displacement occurs in the above-mentioned manner, a shape of an electron beam passing space surrounded by the correction plate of one focusing electrode and the correction plate or the electrode per se of -another focusing electrode is distorted so that a desired electrostatic quadruple lens cannot be formed. This gives rise to a problem that the desired focusing characteristics cannot be obtained over the whole area of the phosphor screen. Accordingly, it has been one of tasks to ensure the interval between respective correction plates within a given size. Further, the rising proximal end of the planar correction plate which is formed at a right angle is bent perpendicularly and hence, burs are liable to be generated at the time of press working and hence, the improvement is also requested in view of the enhancement of the dielectric strength.

### SUMMARY OF THE INVENTION

The present invention provides a color cathode ray tube having an electron gun which can improve focusing characteristics over the whole area of a phosphor screen by solving the above-mentioned drawbacks.

The color cathode ray tube of the present invention includes a plurality of electrode members which constitute an electrostatic quadruple lens in focusing electrodes, wherein one of electrode members which constitute the electrostatic quadruple lens has planar correction electrode plates which extend in parallel to a tube axis direction while sandwiching electron beams and these planar correction electrode plates include reinforcing mechanisms. The typical constitutions of the present invention are explained hereinafter.

(1) A color cathode ray tube includes a vacuum envelope which comprises of a panel having a phosphor screen on an inner surface thereof, a neck housing an electron gun which radiates a plurality of electron beams and a funnel which connects the panel and the neck. A deflector which deflects the electron beams in the horizontal direction and the vertical direction is exteriorly mounted on a neck-side portion of the funnel. In the electron gun, a beam generating portion which generates a plurality of electron beams and comprises of a cathode, a control electrode and an accelerating electrode, focusing electrode which constitute a main electron lens for focusing the electron beams generated by the beam generating portion on the phosphor screen and an anode are arranged in the tube axis direction.

In the cathode ray tube having such a constitution, the focusing electrode includes a plurality of electrode members which constitute an electrostatic quadruple lens, one of electrode members which constitute the electrostatic quadruple lens is provided with planar correction electrode plates extending in parallel to the tube axis direction while sandwiching the electron beams, and the planar correction electrode plates include reinforcing mechanisms.

(2) In the above-mentioned constitution (1), the reinforcing mechanisms formed of the planar correction electrodes may preferably be formed by making a width of proximal portions of the planar correction electrode plates larger than a width of distal end portions of the correction electrode plates.

(3) In the above-mentioned constitution (1) or (2), the reinforcing mechanism provided to the planar correction electrode plates is constituted of an uneven portion formed on the planar correction electrode plate.

(4) In the above-mentioned constitution (1) or (2), the reinforcing mechanism provided to the planar correction electrode plates are constituted of support members fixed to the planar correction electrode plates.

(5) In any one of the above-mentioned constitutions (1) to (4), a distal end portion of the planar correction electrode plate of one electrode which forms the electrostatic quadruple lens of the focusing electrode is inserted into and is arranged in an electron beam aperture of another electrode which forms the electrostatic quadruple lens.

By adopting the above-mentioned respective constitutions, it is possible to extend and arrange the planar correction electrode plates which form the electrostatic quadruple lens substantially parallel to the tube axis and hence, it is possible to obtain desired electrostatic quadruple lens characteristics whereby the focusing characteristics of the electron gun can be improved over the whole area of the phosphor screen.

It is needless to say that the present invention is not limited to the above-mentioned constitution and the constitution of embodiments described later and various modifications can be made without departing from the technical concept of the present invention.

### BRIEF DESCRIPTION OF THE DRAWINGS

FIG. 1 is a cross-sectional side view of an essential part for explaining a specific structure of an inline type electron gun according to an embodiment of a color cathode ray tube of the present invention as viewed from an inline direction.

FIG. 2 is a side view of the electron gun shown in FIG. 1 as viewed from a direction perpendicular to the inline direction.

FIG. 3 is a schematic view showing an example of a combination of electrodes forming an electrostatic quadruple lens of the inline type electron gun of the color cathode ray tube according to the present invention.

FIG. 4a is a plan view of an electrode forming the electrostatic quadruple lens of the inline type electron gun of the color cathode ray tube according to the present invention, FIG. 4b is a cross-sectional view taken along a line B1-B1 in FIG. 4a and FIG. 4c is a cross-sectional view taken along a line C1-C1 in FIG. 4a.

FIG. 5a is a plan view of a second focusing electrode G5-2 forming the electrostatic quadruple lens of the inline type electron gun of the color cathode ray tube according to the present invention, FIG. 5b is a cross-sectional view taken along a line B2-B2 in FIG. 5a and FIG. 5c is a cross-sectional view taken along a line C2-C2 in FIG. 5a.

FIG. 6a is a plan view of an electrode member G5-21 of the second focusing electrode G5-2, FIG. 6b is a cross-sectional view taken along a line B3-B3 in FIG. 6a and FIG. 6c is a cross-sectional view taken along a line C3-C3 in FIG. 6a.

FIG. 7a is a plan view after blanking using a press and before forming by bending of the electrode member G5-21 of the second focusing electrode G5-2 and FIG. 7b is a cross-sectional view taken along a line C4-C4 in FIG. 7a.

FIG. 8a is a top plan view of a planar correction electrode plate QPH used in the electron gun of the color cathode ray tube of the present invention and FIG. 8b is a top plan view of a planar correction electrode plate QPH having a taper along a entire length thereof.

FIG. 9a is a perspective view of a planar correction electrode plate QPH used in the electron gun of the color cathode ray tube of the present invention and FIG. 9b is a cross sectional view taken along a line B5-B5 in FIG. 9a.

FIG. 10a is a perspective view of a planar correction electrode plate QPH used in the electron gun of the color cathode ray tube of the present invention and FIG. 10b is a cross sectional view taken along a line B6-B6 in FIG. 10a.

FIG. 11a is a plan view of a cup-shaped electrode member G5-11 constituting a first focusing electrode G5-1, FIG. 11b is a cross-sectional view taken along a line B7-B7 in FIG. 11a and

FIG. 11c is a cross-sectional view taken along a line C7-C7 in FIG. 11a.

FIG. 12a is a plan view of a cup-shaped electrode member G5-12 constituting a first focusing electrode G5-1, FIG. 12b is a cross-sectional view taken along a line B8-B8 in FIG. 12a and FIG. 12c is a cross-sectional view taken along a line C8-C8 in FIG. 12a.

FIG. 13a is a plan view of a planar electrode member G5-22 constituting a second focusing electrode G5-2, FIG. 13b is a cross-sectional view taken along a line B9-B9 in FIG. 13a and FIG. 13c is a cross-sectional view taken along a line C9-C9 in FIG. 13a.

FIG. 14a is a plan view of a cup-shaped electrode member G5-23 constituting a second focusing electrode G5-2, FIG. 14b is a cross-sectional view taken along a line B10-B10 in FIG. 14a and FIG. 14c is a cross-sectional view taken along a line C10-C10 in FIG. 14a.

FIG. 15 is a schematic cross-sectional view of the color cathode ray tube of the present invention.

FIG. 16 is a schematic cross-sectional view of a conventional inline type electron gun.

FIG. 17 is a schematic view of a cross section of conventional planar horizontal and vertical correction plates in a direction perpendicular to a tube axis.

### DESCRIPTION OF THE PREFERRED EMBODIMENTS

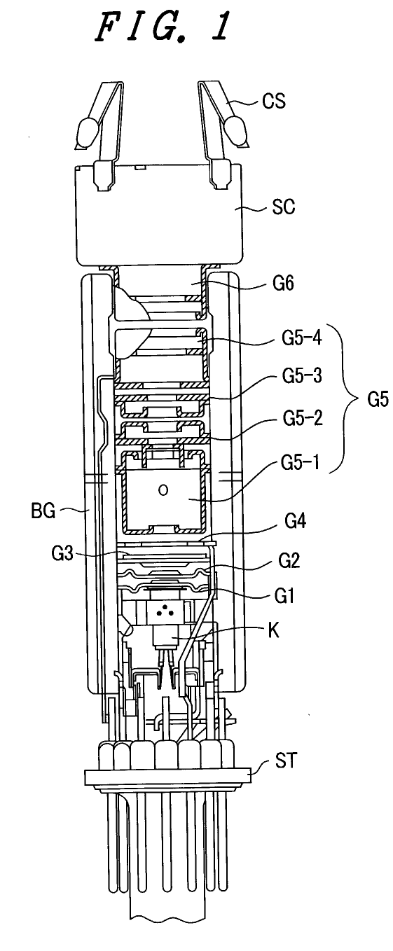

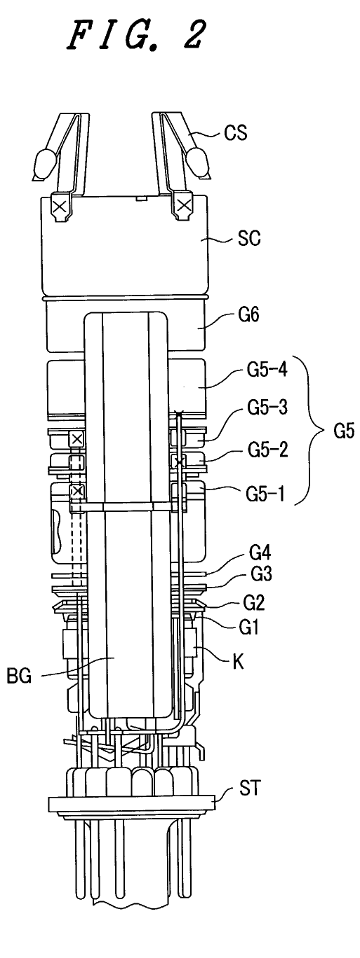

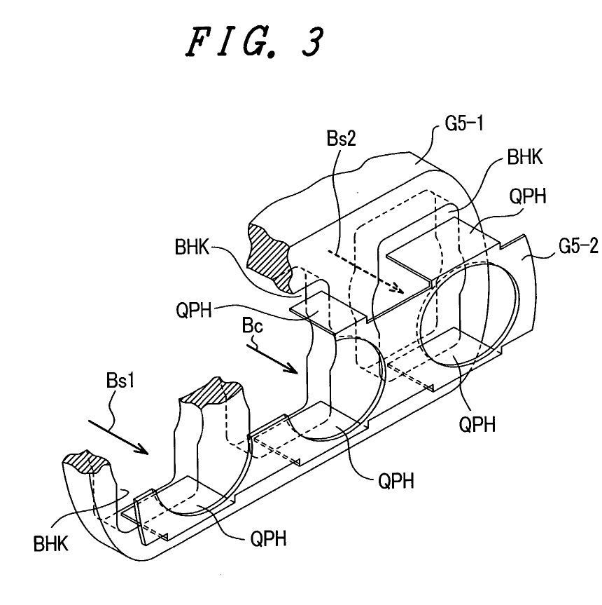

Preferred embodiments of a color cathode ray tube according to the present invention are explained in detail hereinafter in conjunction with drawings. FIG. 1 is a side cross-sectional view of an essential part for explaining a specific structure of an inline type electron gun of an embodiment of a color cathode ray tube according to the present invention and FIG. 2 is a side view of electron gun shown in FIG. 1 as viewed from a direction perpendicular to the inline direction. Further, FIG. 3 is a schematic view showing one example of a combination of electrodes which constitute an electro quadruple lens of the inline type electron gun of the color cathode ray tube according to the present invention.

In FIG. 1 and FIG. 2, K indicates cathodes, G1 indicates a first electrode (control electrode) and G2 indicates a second electrode (acceleration electrode) and a beam generating portion is formed by these cathodes K and acceleration electrode G2. G3 indicates a third electrode and a pre-focusing lens is formed by this third electrode G3 and the second electrode G2.

Then, the above-mentioned constitution is followed by a fourth electrode G4 and a focusing electrode (fifth electrode) G5 which is formed of a mass of a plurality of electrodes. The fourth electrode G4 is electrically connected with the second electrode G2 to have the same potential and a voltage of approximately several hundreds V is applied to the fourth electrode G4. Further, at a rear stage of the focusing electrode G5, an anode electrode (sixth electrode) G6 to which an anode voltage is applied is arranged and a main electron lens is formed between the focusing electrode G5 and the anode electrode G6. A shield cup SC and a plurality of contact springs CS fixed to the shield cup SC are mounted on the anode electrode G6. An anode voltage (maximum voltage) Eb is applied to the sixth electrode G6 from the contact springs CS through the shield cup SC. These respective electrodes are continuously arranged in the tube axis direction toward a phosphor screen from the cathode side, wherein they are fixed at given positions by embedding respective support portions in a pair of beading glasses (multi-form glasses) BG.

Further, the above-mentioned focusing electrode G5 is divided into four section electrodes, that is, a first focusing electrode G5-1, a second focusing electrode G5-2, a third focusing electrode G5-3 and a fourth focusing electrode G5-4 and these focusing electrodes are continuously arranged in the tube axis direction. The first focusing electrode G5-1 and the third focusing electrode G5-3 are electrically connected to the third electrode 4 and a fixed focusing voltage is applied to the first and second focusing electrodes G5-1, G5-3. On the other hand, the fourth focusing electrode G5-4 which is arranged to face the sixth electrode (anode) G6 in an opposed manner and forms the main lens is electrically connected with the second focusing electrode G5-2 and a dynamic correction voltage which is formed by superposing a dynamic voltage changing in synchronism with a deflection quantity to a fixed focusing voltage is applied to the fourth focusing electrode G5-4.

On the other hand, out of the divided focusing electrodes of the focusing electrode G5 which constitute the above-mentioned focusing lens, one example of the first focusing electrode G5-1 which constitutes another electrode for forming the electrostatic quadruple lens and the second focusing electrode G5-2 which constitutes one electrode is shown in FIG. 3 which is a schematic view. As shown in the drawing, the first focusing electrode G5-1 constituting another electrode has three keyhole-shaped electron beam apertures BHK having a long axis in the direction perpendicular to a surface which faces the second focusing electrode G5-2 constituting one electrode.

Further, the second focusing electrode G5-2 of the focusing electrode G5 constituting one electrode includes plural pairs of planar correction electrode plates QPH, wherein each pair of planar correction electrode plates QPH sandwich each one of a plurality (here, three pieces) of electron beams Bc, Bs1, Bs2 (electron beam apertures BHR) in the vertical direction and project in the direction toward the first focusing electrode G5-1 constituting another electrode parallel to the tube-axis direction. These planar correction electrode plates QPH constitute a reinforcing mechanism which will be explained later. Each pair of planar correction electrode plates QPH of the second focusing electrode G5-2 have distal end portions thereof inserted into the keyhole-shaped electron beam aperture BHK between both longitudinal ends of the aperture BHK. Accordingly, the electrostatic quadruple lens is formed including a superposed portion of both electrodes formed by the insertion of the correction electrode plates QPH.

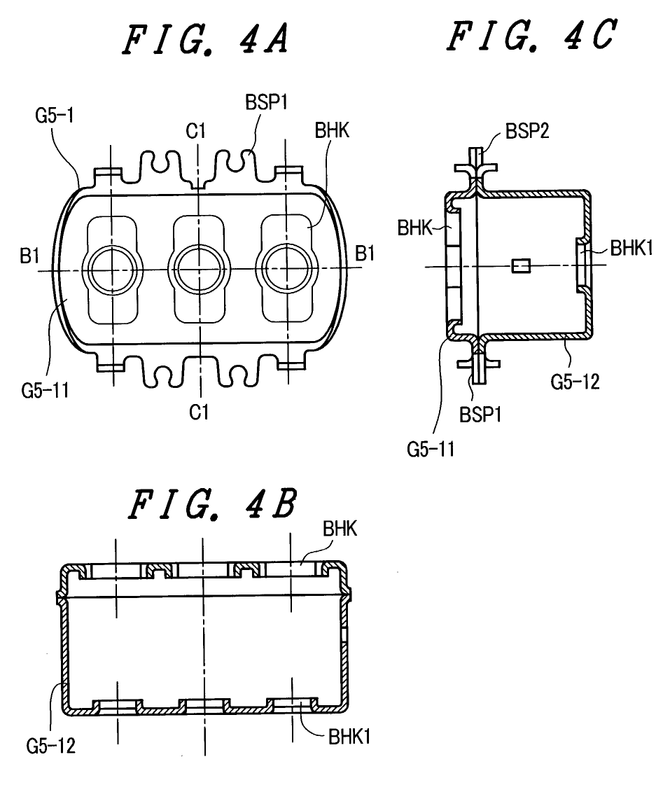

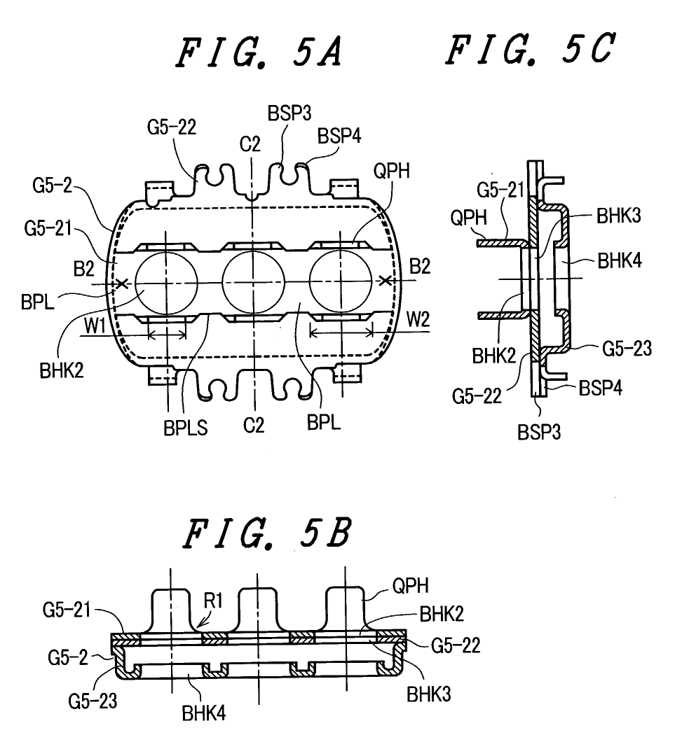

FIG. 4 and FIG. 5 are views respectively showing the specific constitutional examples of the first focusing electrode G5-1 and the second focusing electrode G5-2. First of all, FIG. 4a, FIG. 4b and FIG. 4c show one example of the first focusing electrode G5-1, wherein FIG. 4a is a plan view, FIG. 4b is a cross-sectional view taken along a line B1-B1 in FIG. 4a and FIG. 4c is a cross-sectional view taken along a line C1-C1 in FIG. 4a. The first focusing electrode G5-1 is constituted by making an open-end side of a cup-shaped electrode member G5-11 which arranges three electron beam apertures BHK in a closed end face in line and an open-end side of a cup-shaped electrode member G5-12 which arranges three circular electron beam apertures BHK1 formed in a burring shape in a closed end face in line butt each other while aligning the centers of the electron beam apertures BHK with the electron beam apertures BHK1 and, thereafter, by fixing them using a welding technique. Further, both of the electrode member G5-11 and the electrode member G5-12 respectively have support portions BSP1, BSP2 which are embedded into the beading glasses BG.

The electron beam apertures BHK formed in the closed end face of the first focusing electrode G5-1 are the keyhole-shaped electron beam apertures having a long-axis thereof in the vertical direction. Here, the keyhole shape is a shape which has arcuate notches at two opposing sides of an opening having four sides such as the electron beam aperture BHK.

Further, FIG. 5a is a plan view of the second focusing electrode G5-2, FIG. 5b is a cross-sectional view taken along a line B2-B2 in FIG. 5a and FIG. 5c is a cross-sectional view taken along a line C2-C2 in FIG. 5a. The second focusing electrode G5-2 is constituted of an electrode member G5-21 having an approximately U shape, a planar electrode member G5-22 and a cup-shaped electrode member G5-23. The approximately U-shaped electrode member G5-21 is welded to the planar electrode member G5-22 and the cup-shaped electrode member G5-23 has an open end welded to the planar electrode member G5-22. Respective pairs of planar correction electrode plates QPH sandwich the above-mentioned three electron beams Bc, Bs1, Bs2 respectively in the vertical direction and project in the direction toward the first focusing electrode G5-1 parallel to the tube axis direction. The centers of the electron beam apertures BHK2 are aligned with the centers of distances between respective pairs of planar correction electrode plates QPH and are arranged in line with a bottom wall portion BPL. The planar electrode member G5-22 is fixed to the bottom plate portion BPL of the electrode member G5-21. The electron beam apertures BHK3 of the electrode member G5-22 have the same center and the same diameter as the electron beam apertures BHK2. The cup-shaped electrode member G5-23 has three circular electron beam apertures BHK4 formed in a closed end face in a burring shape in line and has an open end thereof fixed to the planar electrode member G5-22 by welding. Further, the electrode members G5-22 and the electrode G5-23 respectively have support portions BSP3, BSP4 which are respectively embedded in the beading glass BG.

The electrode member G5-21 of the second focusing electrode G5-2 has a width W2 at a proximal end of a bent portion of the planar correction electrode plate QPH which is larger than a width W1 of a distal end portion of the bent portion and a curved shape having a given radius of curvature R1 is provided to a transitional portion where the width of the correction electrode plate QPH changes between the width W1 and the width W2.

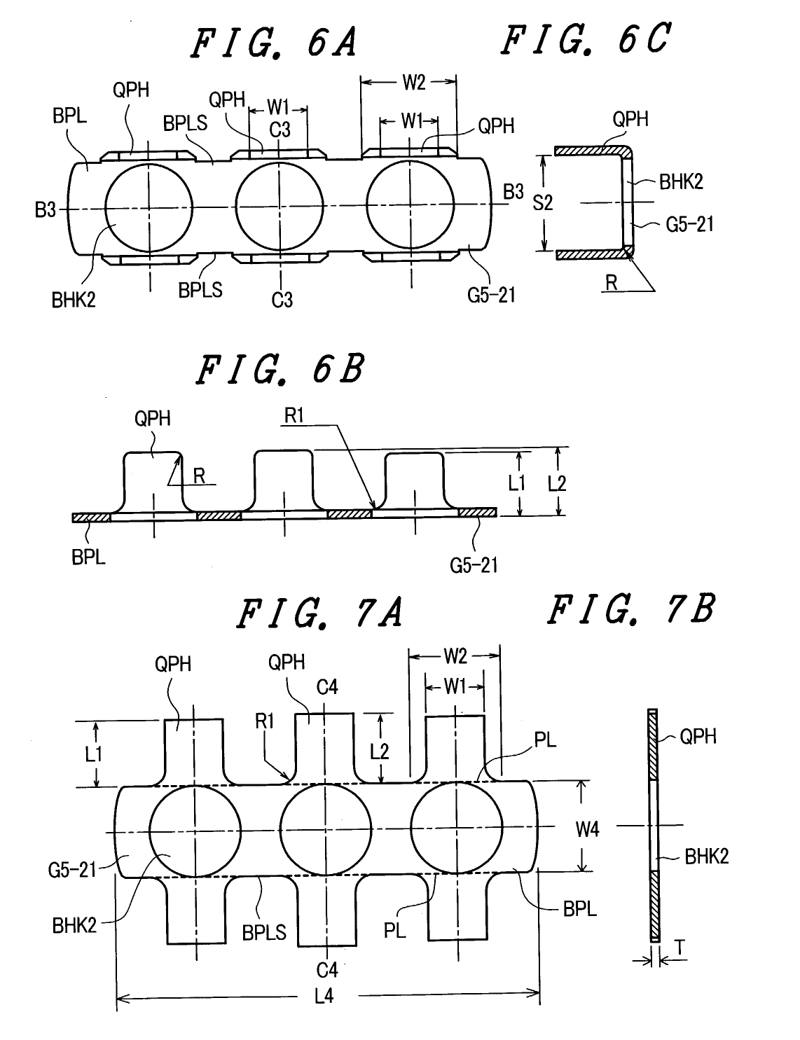

FIG. 6a is a plan view of the electrode member G5-21 of the second focusing electrode G5-2, FIG. 6b is a cross-sectional view taken along a line B3-B3 in FIG. 6a and FIG. 6c is a cross-sectional view taken along a line C3-C3 in FIG. 6a. Parts identical with the parts shown in the previously mentioned respective drawings are given the same symbols. The planar correction electrode plates QPH are bent at an approximately right angle from both end portions BPLS of the bottom wall portion BPL in a state that the correction electrode plates QPH sandwich three electron beam apertures BHK2 respectively. The bent plates have the structure in which the plates are erected with a height L1 or L2. Further, the bent plates which face in an opposed manner defines a distance S2 therebetween. The planar correction electrode plate QPH has a width W2 at a proximal portion thereof which is wider than the width W1 of the distal end portion thereof and the transitional portion where the width of the correction electrode plate QPH changes between the width W1 and the width W2 is provided with a continuous curved surface having a radius of curvature R1 thus exhibiting a flared shape.

FIG. 7a is a plan view after blanking a press and before forming by bending of the electrode member G5-21 of the second focusing electrode G5-2 and FIG. 7b is a cross-sectional view taken along a line C4-C4 in FIG. 7a. In these drawings, parts identical with parts shown in the above-mentioned respective drawings are given the same symbols. The planar correction electrode plate QPH is formed such that a width W2 of a proximal portion thereof is larger than a width W1 of a distal end portion thereof and the transitional portion where the width of the correction electrode plate QPH changes between the width W1 and the width W2 is provided with a continuous curved surface having a radius of curvature R1. Forming by bending is performed at a position of a bent portion PL which is indicated by a dotted line connecting points of the width W2. Here, L4 indicates an entire length of the bottom wall portion BPL, W4 indicates a width of the bottom wall portion BPL and the T indicates a plate thickness.

By forming the transitional portion where the width of the correction electrode QPH changes between the width W1 of the distal end portion and the width W2 of the proximal portion by the curved surface having a given radius of curvature R1, the planar correction electrode plate QPH exhibits a shape having a flared proximal end portion. Compared to the conventional structure in which the correction electrode plate has a uniform width over the entire length (entire height), it is possible to enhance the mechanical strength of the correction electrode plate QPH and hence, the deformation and the displacement of the correction electrode plate QPH which are generated conventionally can be obviated. Further, since the mechanical strength can be enhanced, it is possible to increase the entire length (L1, L2) of the correction electrode plate QPH whereby the strength of the electrostatic quadruple lens can be increased. Further, since the proximal end portion exhibits the curved surface having the radius of curvature R1, along with the suppression of the occurrence of burrs at the time of performing blanking using a press (press working), it is also possible to enhance the dielectric strength between opposing electrodes whereby the lens diameter can be enlarged.

Then, to show a specific example of the above-mentioned respective sizes, they are as follows. In a nominal 29 type color cathode ray tube, the above-mentioned respective sizes are set such that W1: 3 mm, W2: 4.8 mm, R1: 0.9 mm, L1: 3.5 mm, L4: 21.5 mm, W4: 4.7 mm, T: 0.4 mm, S2: 4.9 mm, BHK2: 4.5 mmφ.

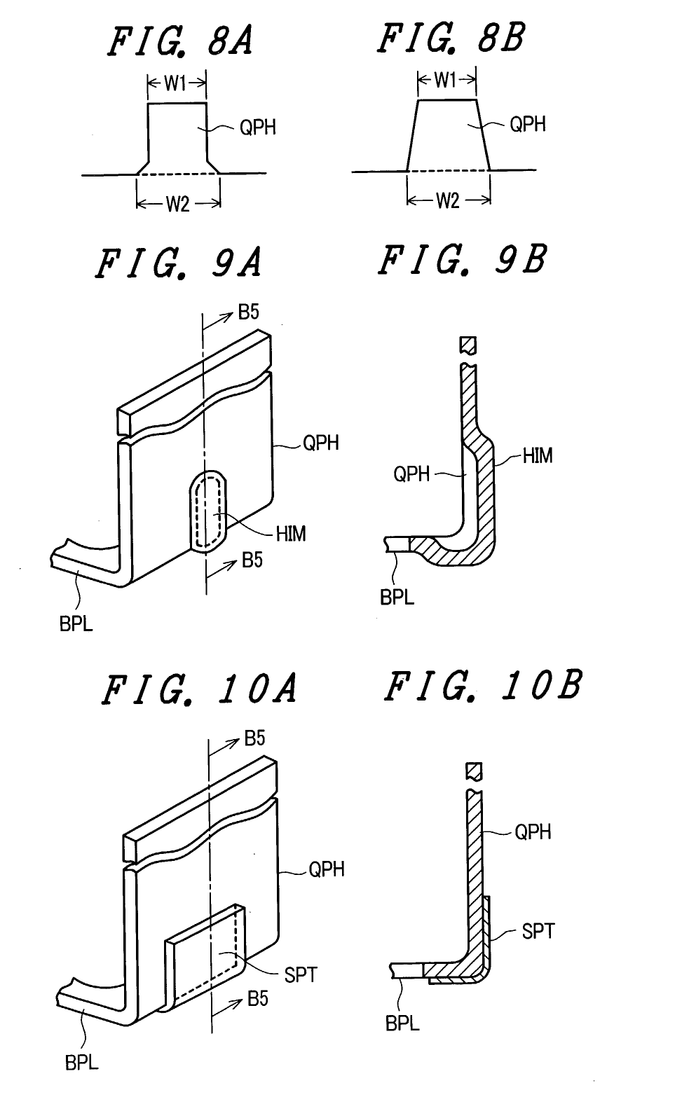

Then, FIG. 8a is an explanatory view showing another example the planar correction electrode plate QPH served for the electron gun of the color cathode ray tube of the present invention and is also a top plan view of the planar correction electrode plate QPH which is provided with a taper at the proximal end thereof. On the other hand, FIG. 8b is a top plan view of the planar correction electrode plate QPH which is provided with a taper over the entire length thereof. Both correction electrode plates shown in FIG. 8a and FIG. 8b are provided with features which can obviate the deformation and displacement thereof which have been drawbacks of the conventional technique.

FIG. 9a and FIG. 9b are views which schematically show an essential part of still another example of the planar correction electrode plate QPH served for the electron gun of the color cathode ray tube of the present invention. In the planar correction electrode plate QPH shown in FIG. 9a and FIG. 9b, a rectangular projection HIM is continuously formed from the bottom wall portion BPL to the planar correction electrode plate QPH by press forming or the like and the mechanical strength is enhanced by using this irregularities as the reinforcing mechanism. Here, FIG. 9a is a perspective view and FIG. 9b is a cross-sectional view taken along a line B5-B5 in FIG. 9a.

FIG. 10a and FIG. 10b are views which schematically show an essential part of still another example of the planar correction electrode plate QPH served for the electron gun of the color cathode ray tube of the present invention. In the planar correction electrode plate QPH shown in FIG. 10a and FIG. 10b, an L-shaped auxiliary body SPT which constitutes a separate body is fixed from the bottom wall portion BPL to the planar correction electrode plate QPH so as to enhance the mechanical strength of the correction electrode plate QPH. Here, FIG. 10a is a perspective view and FIG. 10b is a cross-sectional view taken along a line B6-B6 in FIG. 10a.

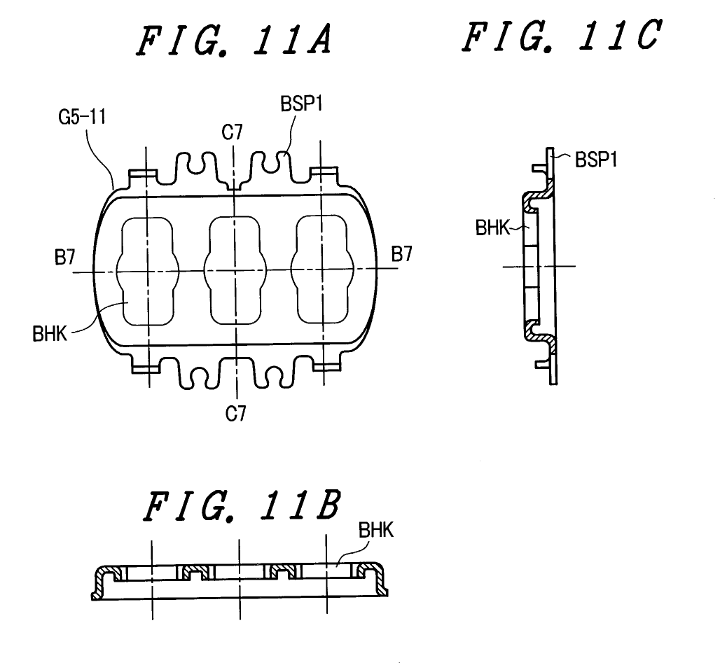

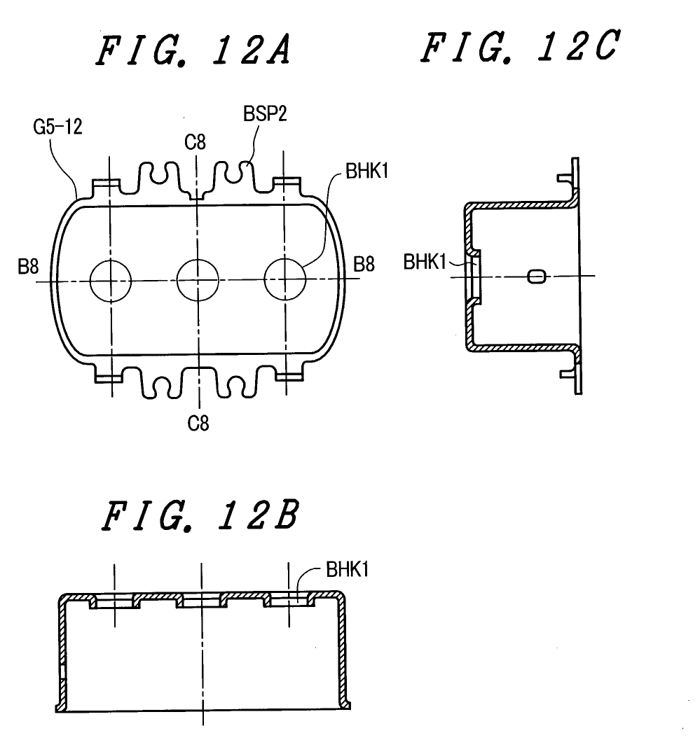

FIG. 11a, FIG. 11b and FIG. 11c are views for showing an example of each electrode member which constitutes the first focusing electrode G5-1 and the second focusing electrode G5-2. FIG. 11a is a plan view showing a cup-shaped electrode member G5-11 which constitutes the first focusing electrode G5-1, FIG. 11b is a cross-sectional view taken along a line B7-B7 in FIG. 11a and FIG. 11c is a cross-sectional view taken along a line C7-C7 in FIG. 11a. Parts in the drawings which are identical with the parts shown in the above-mentioned respective drawings are given same symbols and the overlapped explanation is omitted. FIG. 12a is a plan view showing a cup-shaped electrode member G5-12 which constitutes the first electrode G5-1, FIG. 12b is a cross-sectional view taken along a line B8-B8 in FIG. 12a and FIG. 12c is a cross-sectional view taken along a line C8-C8 in FIG. 12a. Parts in the drawings which are identical with the parts shown in the above-mentioned respective drawings are given same symbols and the overlapped explanation is omitted.

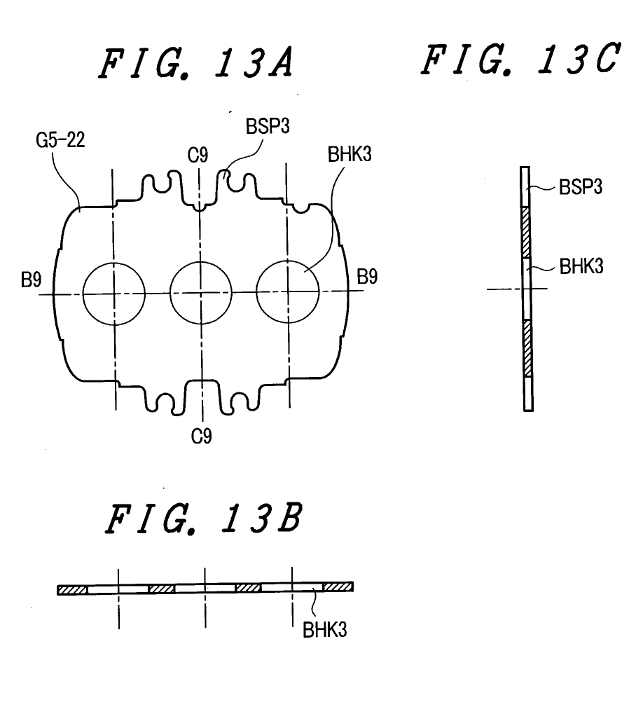

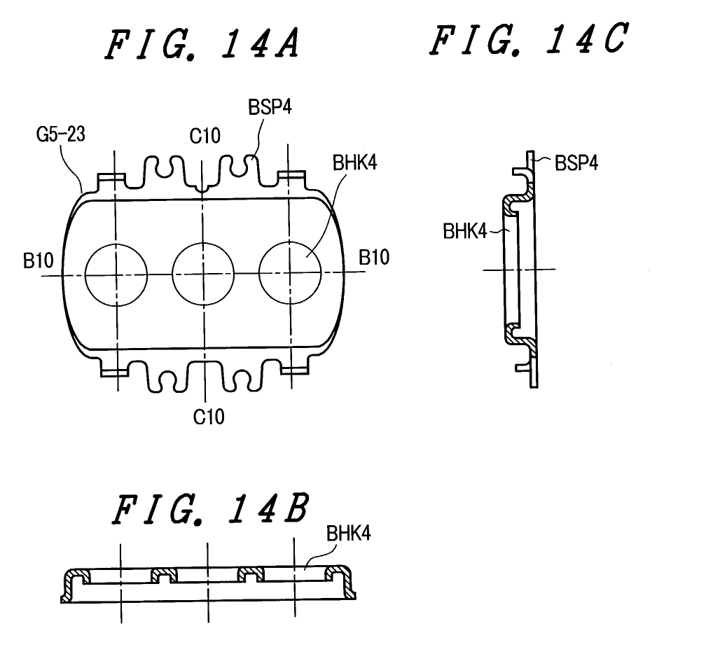

FIG. 13a is a plan view showing a planar electrode member G5-22 which constitutes the second focusing electrode G5-2, FIG. 13b is a cross-sectional view taken along a line B9-B9 in FIG. 13a and FIG. 13c is a cross-sectional view taken along a line C9-C9 in FIG. 13a. Parts in the drawings which are identical with the parts shown in the above-mentioned respective drawings are given same symbols and the overlapped explanation is omitted. FIG. 14a is a plan view showing a cup-shaped electrode member G5-23 which constitutes the second focusing electrode G5-2, FIG. 14b is a cross-sectional view taken along a line B10-B10 in FIG. 14a and FIG. 14c is a cross-sectional view taken along a line C10-C10 in FIG. 14a. Parts in the drawings which are identical with the parts shown in the above-mentioned respective drawings are given same symbols and the overlapped explanation is omitted.

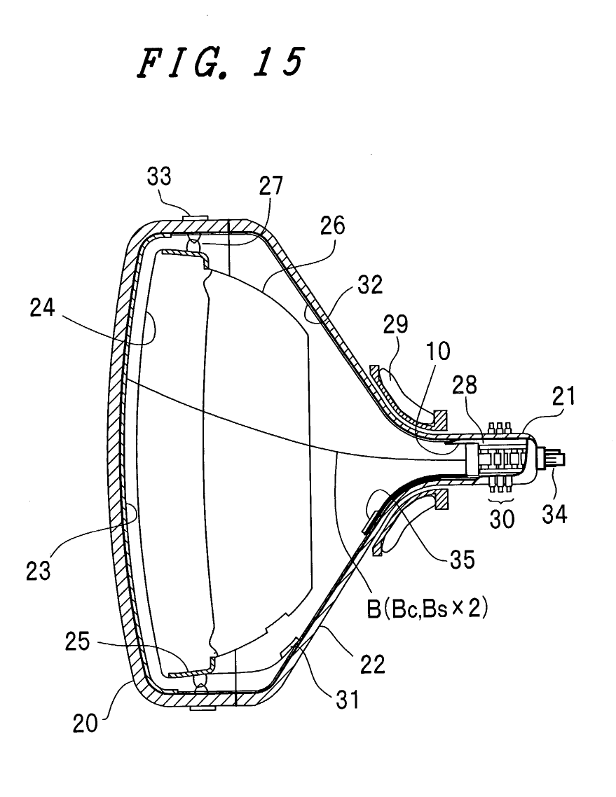

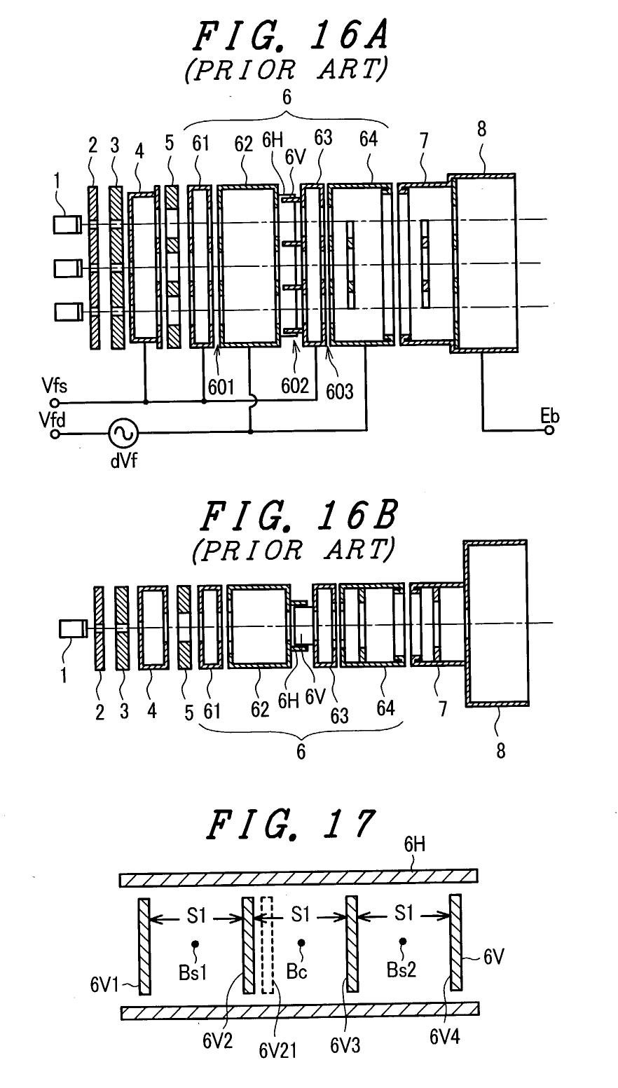

Then, FIG. 15 is a schematic cross-sectional view for explaining a schematic constitution of an embodiment of the color cathode ray tube according to the present invention. The color cathode ray tube includes a vacuum envelope which is constituted of a panel portion 20 which arranges a shadow mask 24 in the vicinity of a phosphor screen 23 which is applied to an inner surface thereof, a neck portion 21 which houses the above-mentioned inline type electron gun 28 of the cathode ray tube of the present invention shown in FIG. 1 and FIG. 2, and a funnel portion 22 which connects the panel portion 20 and the neck portion 21. The shadow mask 24 is held by a mask frame 25 and is supported by studs which are mounted in an erected manner on inner surfaces of side walls of the panel portion 20 by means of a spring suspension mechanism 27. Here, an inner shield 26 which shields an external magnetic field such as earth magnetism is mounted on the mask frame 25. To an anode electrode of the inline type electron gun 28 housed in the neck portion 21, an anode voltage which is a maximum voltage is applied through an inner conductive film 32 applied to an inner wall of the vacuum envelope by way of contact springs 10. The maximum voltage is applied from outside through an anode button (not shown in the drawing) which is formed in the funnel portion such that the anode button penetrates a wall of the funnel portion.

A deflection yoke 29 is exteriorly mounted on a transitional area between the neck portion 21 and the funnel portion 22 and deflects electron beams B (center beam Bc, side beams Bs1, Bs2) irradiated from the electron gun 28 in two directions consisting of the horizontal direction and the vertical direction and reproduces a two-dimensional image on a screen which is formed of a phosphor surface 23. An external correction magnetic device 30 which is served for adjusting the centering of electron beams and the color purity is mounted on an outside of the neck portion 21. Numeral 31 indicates a getter which is mounted on the mask frame 25. By heating the getter using an external heating means, the degree of vacuum in the vacuum envelope can be increased. Here, stem pins are mounted in an erected manner on an end portion of the neck portion and these stem pins supply video signals or operational potentials to the electron gun 28 from external circuits. Numeral 33 indicates an implosion prevention band which is served for preventing the implosion of the vacuum envelope by tightening the vicinity of the joining portion between the panel portion 20 and the funnel portion 22.

The present invention is not limited to the above-mentioned embodiments and various modifications are considered without departing from the technical concept of the present invention.

As has been described heretofore, according to the present invention, by providing the reinforcing mechanism to the planar correction electrode plates which form the electrostatic quadruple lens, the deformation and the displacement of the correction electrode plates can be obviated whereby it is possible to provide the color cathode ray tube provided with the inline type electron gun having the excellent focusing characteristics over the whole screen.

What is claimed is:

1. A color cathode ray tube including a vacuum envelope which coomprises a panel having a phosphor screen on an inner surface thereof, a neck housing an electron gun and a funnel which connects the panel and the neck, wherein
the electron gun forms a beam generating portion which comprises a cathode, a control electrode and an accelerating electrode and forms a main electron lens using a focusing electrode and an anode, and
the focusing electrode includes a plurality of electrode members which constitute an electrostatic quadruple lens, one of electrode members which constitute the electrostatic quadruple lens is provided with correction electrodes extending in parallel to a tube axis direction while sandwiching electron beams, and the correction electrodes include reinforcing mechanisms.

2. A color cathode ray tube according to claim 1, wherein the reinforcing mechanism is an uneven portion formed on the correction electrode.

3. A color cathode ray tube according to claim 1, wherein the reinforcing mechanism is a support member fixed to the correction electrode.

4. A color cathode ray tube according to claim 1, wherein a planar correction electrode plate which constitutes one electrode forming the electrostatic quadruple lens of the focusing lens is arranged in a superposed manner inside an electron beam aperture of another electrode which forms the electrostatic quadruple lens.

5. A color cathode ray tube according to claim 1, wherein the reinforcing mechanism is constituted by making a width of a proximal portion of the correction electrode larger than a width of a distal end portion of the correction electrode.

6. A color cathode ray tube according to claim 1, wherein the reinforcing mechanism is constituted of an uneven portion formed on the correction electrode.

7. A color cathode ray tube according to claim 1, wherein the reinforcing mechanism is constituted of a support member fixed to the correction electrode.

8. A color cathode ray tube according to claim 6, wherein a planar correction electrode plate which constitutes one electrode forming the electrostatic quadruple lens of the focusing lens is arranged inside a superposed manner in an electron beam aperture of another electrode which forms the electrostatic quadruple lens.
